(19) United States
(12) Patent Application Publication
(10) Pub. No.: US 2012/0073694 A1
(43) Pub. Date: Mar. 29, 2012

(54) AUTOMOTIVE AIR DUCT CONSTRUCTION

(75) Inventors: Michael G. Leffert, Howell, MI (US); David M. Hammelef, Novi, MI (US); Khalil Ahmed, Rochester, MI (US); Edmund M. Mizgalski, Sterling Heights, MI (US)

(73) Assignee: GM GLOBAL TECHNOLOGY OPERATIONS, INC., Detroit, MI (US)

(21) Appl. No.: 12/890,784

(22) Filed: Sep. 27, 2010

(51) Int. Cl. F16L 9/14

(52) U.S. Cl. 138/177

(57) ABSTRACT

A cooling duct connects a passenger compartment of a vehicle and an energy storage system in fluid communication, and directs a flow of air from the passenger compartment to the energy storage system to cool the energy storage system. The cooling duct includes a first portion that is formed from a non-porous material, and a second portion that is formed from a porous material. The first portion and the second portion are attached to define an enclosed flow path. The second portion includes an airflow resistivity that allows air infiltration into the second portion, through the porous material, at a rate of between zero percent (0%) and twenty percent (20%) of a minimum flow rate when an inlet of the cooling duct is unobstructed, and at a rate of at least thirty percent (30%) when the inlet is completely obstructed.

### TECHNICAL FIELD

The invention generally relates to a cooling duct for a vehicle, and more specifically to a cooling duct for directing a flow of air from a passenger compartment of the vehicle to an energy storage system of the vehicle to cool the energy storage system.

### BACKGROUND

Some vehicles, including but not limited to hybrid or electric vehicles, include an energy storage system located within an interior space of the vehicle. The energy storage system requires cooling to operate properly. In order to provide a flow of air to cool the energy storage system, some vehicles include a cooling duct connecting a passenger compartment of the vehicle with the energy storing system to direct a flow of air from the passenger compartment to the energy storage system. For example, the cooling duct may include an inlet that opens into the passenger compartment at a rear deck lid separating the passenger compartment from a trunk space of the vehicle.

### SUMMARY

A vehicle is provided. The vehicle includes a body defining a passenger compartment. An energy storage system is supported by the body, and is disposed externally of the passenger compartment. A cooling duct is in fluid communication with the passenger compartment and the energy storage system. The cooling duct defines an inlet into the passenger compartment. The cooling duct is configured for drawing a flow of air from the passenger compartment at a minimum flow rate, and directing the flow of air to the energy storage system to cool the energy storage system. The cooling duct includes a first portion and a second portion. The first portion is formed from a non-porous material. The second portion is formed from a porous material. The second portion is attached to the first portion to define an enclosed flow path for the flow of air. The second portion includes an airflow resistivity. The airflow resistivity allows air infiltration through the porous material at a rate of between zero percent (0%) and twenty percent (20%) of the minimum flow rate when the inlet is unobstructed, and at a rate of at least thirty percent (30%) when the inlet is completely obstructed.

A cooling duct for connecting a passenger compartment of a vehicle and an energy storage system in fluid communication is also provided. The cooling duct directs a flow of air from the passenger compartment to the energy storage system to cool the energy storage system. The cooling duct includes a first portion formed from a non-porous material, and a second portion formed from a porous material. The second portion is attached to the first portion to define an enclosed flow path for the flow of air. The second portion includes an airflow resistivity. The airflow resistivity allows air infiltration through the porous material at a rate of between zero percent (0%) and twenty percent (20%) of the minimum flow rate when the inlet is unobstructed, and at a rate of at least thirty percent (30%) when the inlet is completely obstructed.

Accordingly, by forming the cooling duct from the non-porous first portion and the porous second portion, the air infiltration requirements, which require that the energy storage system is supplied with a flow of cooling air even if the inlet of the cooling duct is obstructed, and the noise and vibration requirements for the vehicle may be customized or tuned to meet the specific needs of the vehicle, while minimizing cost of the cooling duct.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view of a vehicle.

FIG. 2 is a partially exploded schematic perspective view of a cooling duct coupled to an energy storage system.

FIG. 3 is a schematic cross section of the cooling duct taken along cut line 3-3 shown in FIG. 1.

FIG. 4 is schematic perspective view of an alternative embodiment of the cooling duct.

FIG. 5 is a schematic cross section of the alternative embodiment of the cooling duct taken along cut line 5-5 shown in FIG. 4.

FIG. 6 is a schematic cross section of the alternative embodiment of the cooling duct taken along cut line 6-6 shown in FIG. 4.

### DETAILED DESCRIPTION

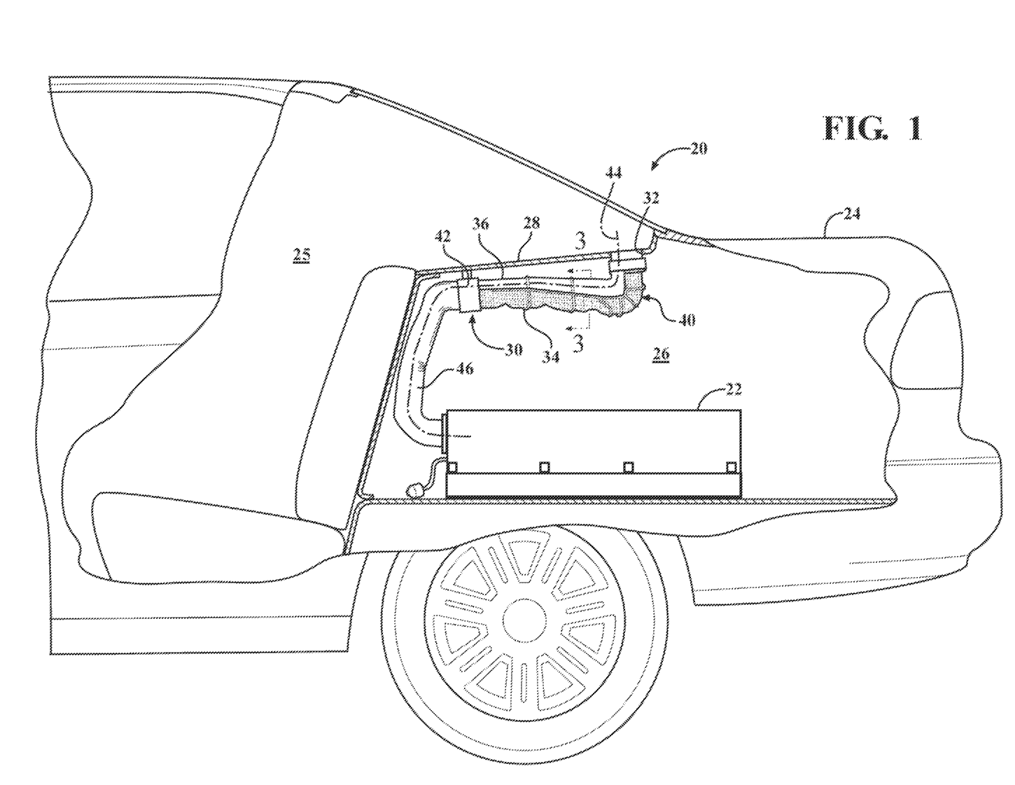

Referring to the Figures, wherein like numerals indicate like parts throughout the several views, a vehicle is shown generally at 20 in FIG. 1. The vehicle 20 may include, but is not limited to, a hybrid vehicle 20 or an electric vehicle 20 having an energy storage system 22. The energy storage system 22 may include, but is not limited to, a battery or similar device.

Referring to FIG. 1, the vehicle 20 includes a body 24 defining a passenger compartment 25. The energy storage system 22 is supported by the body 24, and is disposed externally of the passenger compartment 25. In other words, the energy storage system 22 is not disposed within the passenger compartment 25. For example, the body 24 may further define an interior space 26, which is separate and distinct from the passenger compartment 25, in which the energy storage system 22 is located. The vehicle 20 may further include, for example, a rear deck lid 28 or similar divider, at least partially separating the passenger compartment 25 from the interior space 26.

The vehicle 20 further includes a cooling duct 30. The cooling duct 30 is in fluid communication with the passenger compartment 25 and the energy storage system 22. The cooling duct 30 defines an inlet 32 into the passenger compartment 25, through which air may flow from the passenger compartment 25, through the cooling duct 30, and into the energy storage system 22. The cooling duct 30 is configured for drawing a flow of air from the passenger compartment 25 at a minimum flow rate, and directing the flow of air to the energy storage system 22 to cool the energy storage system 22.

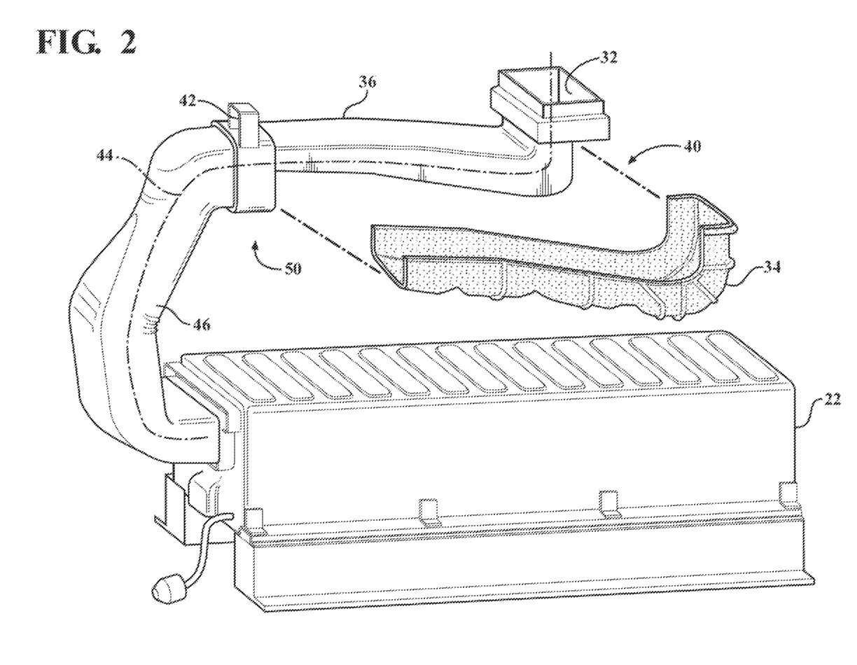

Referring also to FIGS. 2 and 3, the cooling duct 30 includes a first portion 34 and a second portion 36. The first portion 34 is formed from a non-porous material. The non-porous material of the first portion 34 may include, but is not limited to, a plastic material or the like. For example, the first portion 34 may be formed by a blow molding process from a thermoplastic resin such as polypropylene (PP), polyethylene (PE), polyamide (PA), polyester (for example, polyethylene terephthalate (PET)) or polystyrene (PS).

The second portion 36 is formed from a porous material. The porous material of the second portion 36 may include, but is not limited to, a compressed mat of either natural fibers bonded together or synthetic fibers bonded together. For example, the second section of porous material may be formed by laminating two types of polyethylene terephthalate (PET) fibers without weaving them, performing needle punching on the laminated structure, and forming the resulting original non-woven fabric into a shape that defines the second portion 36 through a hot-press molding process.

The above-identified two types of PET fibers may be comprised of regular fibers and binder fibers. The regular fibers are high-melting-point fibers and the binder fibers are low-melting-point fibers. Each of the regular fibers is constructed with a water-repelling layer made of a water repellent material, such as fluorine- or silicon-based water repellent, formed around a core material of a high-melting-point PET resin. The melting point of the high-melting-point PET resin constituting the core material is preferably in the range of 220° C. to 260° C. The outer diameter of the regular fiber is preferably in the range of 10 μm to 100 μm, and more preferably, in the range of 30 μm to 50 μm. The compounding weight ratio of the regular fibers in the original non-woven fabric is preferably in the range of 50 to 90%, and more preferably, in the range of 65 to 75%.

The binder fiber is constructed with a binder layer, made of a low-melting-point PET resin, formed around a core material similar to that of the regular fiber. In the case where the low-melting-point PET resin constituting the binder layer has a crystalline property, the melting point of the PET resin is preferably in the range of 120° C. to 190° C., and more preferably, in the range of 140° C. to 170° C. In the case where the PET resin has a non-crystalline property, the melting point thereof is preferably in the range of 100° C. to 190° C., and more preferably, in the range of 120° C. to 170° C. Moreover, the binder fiber is formed with a smaller thickness than the regular fiber, and the outer diameter of the binder fiber is preferably in the range of 10 μm to 100 μm, and more preferably, in the range of 15 μm to 25 μm. Moreover, the compounding ratio of the binder fibers in the original non-woven fabric is preferably in the range of 10 to 50%, and more preferably, in the range of 25 to 35%.

As described above, the non-woven fabric is prepared by compressing the original non-woven fabric to a predetermined thickness using a mold heated to about 200° C. by the hot-press molding process. With the hot-press molding thus performed, the binder layers of the binder fibers contained in the original non-woven fabric are brought into a fused or molten state, and the regular fibers and the binder fibers are fused and bonded together at their contact points. Thus, a three-dimensional network structure formed by needle-punching the original non-woven fabric is fixed within the non-woven fabric. In other words, the regular fibers and the binder fibers are three-dimensionally entwined with each other and fixed in this state.

The second portion 36 is attached to the first portion 34 to define an enclosed flow path 38 for the flow of air, shown in FIG. 3. When attached together, the first portion 34 and the second portion 36 define a composite section 40. The first portion 34 and the second portion 36 may be attached and/or joined together in any suitable manner, including but not limited to, a hot plate welding process, a plurality of fasteners, or by a coupling 42 interconnecting the first portion 34 and the second portion 36. The enclosed flow path 38 may include any shape, configuration and/or orientation suitable to connect the inlet 32 to the energy storage system 22 in fluid communication. Additionally, the enclosed flow path 38 includes a cross section perpendicular to a longitudinal axis 44 of the cooling duct 30 that defines a closed shape. The closed shape may include any suitable shape, including but not limited to a generally rectangular shape.

As shown in FIG. 3, the first portion 34 of the cooling duct 30 includes a cross section having a non-linear shape perpendicular to the longitudinal axis 44 of the cooling duct 30. The second portion 36 also includes a cross section having a non-linear shape perpendicular to the longitudinal axis 44 of the cooling duct 30. The non-linear cross sectional shape of the first section mates with the non-linear cross sectional shape of the second portion 36 to define the enclosed flow path 38 therebetween. The non-linear cross sectional shape of the first portion 34 of the cooling duct 30 and the non-linear cross sectional shape of the second portion 36 of the cooling duct 30 may each include, but are not limited to, a generally concave U-shaped configuration. The generally concave U-shaped configuration of the first portion 34 and the second portion 36 mate together to define a generally rectangular closed shape perpendicular to the longitudinal axis 44 of the cooling duct 30. It should be appreciated that the non-linear cross sectional shapes of the first portion 34 and the second portion 36, and the resulting cross sectional shape of the composite section 40 may differ from that shown and described herein.

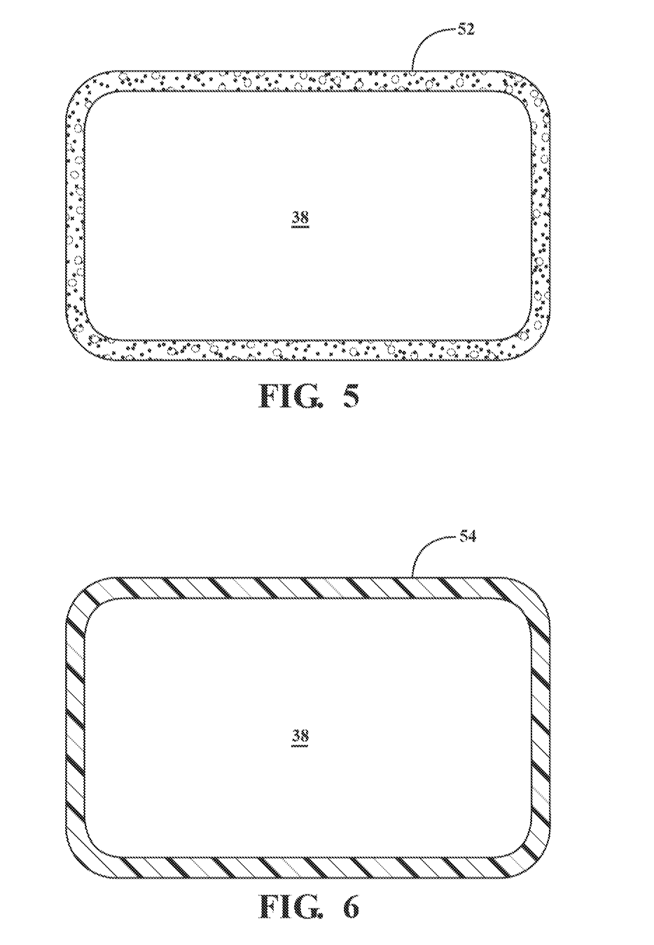

The cooling duct 30 may further include a third portion 46. The third portion 46 may be formed from the same or similar non-porous material used to form the first portion 34. The third portion 46 includes a cross section perpendicular to the longitudinal axis 44 the cooling duct 30 that defines an enclosed shape, such as that shown in FIG. 6. As shown, the third portion 46 is arranged end to end with the composite section 40, i.e., the combined first portion 34 and second portion 36, to define the entire length of the enclosed flow path 38 and the cooling duct 30.

The second portion 36 includes an airflow resistivity. The airflow resistivity allows air infiltration through the porous material, and into the cooling duct 30. Accordingly, air is drawn from the passenger compartment 25 through the inlet 32 into the cooling duct 30, and also through the porous material of the second portion 36 into the cooling duct 30. The air may flow through the porous material of the second portion 36 at a rate of between zero percent (0%) and twenty percent (20%) of the minimum flow rate when the inlet 32 is unobstructed. More preferably, the air may flow through the porous material of the second portion 36 at a rate of between zero percent (0%) and ten percent (10%) of the minimum flow rate when the inlet 32 is unobstructed. The air may flow through the porous material of the second portion 36 at a rate of at least thirty percent (30%) when the inlet 32 is completely obstructed. More preferably, the air may flow through the porous material of the second portion 36 at a rate of at least fifty percent (50%) when the inlet 32 is completely obstructed. This ensures that the energy storing system receives enough cooling air to operate properly even if the inlet 32 of the cooling duct 30 is blocked, yet still maintains a proper pressure drop across the cooling duct 30.

The airflow resistivity may be measured in Rayles. A Rayle is a unit of measure that is equal to the quotient of a suction pressure within the cooling duct 30 divided by a flow rate of the air through the cooling duct 30, multiplied by a surface area of the second portion 36 of the cooling duct 30.

The airflow resistivity may include a maximum resistivity and a minimum resistivity. The maximum resistivity and the minimum resistivity are respectively equal to: maximum resistivity=(n)×(6,130 Rayles); and minimum resistivity=(n)×(3,680 Rayles). The variable “n” is equal to the percentage of the total surface area defined by the second portion 36 of the cooling duct 30. Accordingly, if one half (½) of the total surface area of the cooling duct 30 is defined by the second portion 36, then n=0.5, the maximum resistivity is equal to 3,066 Rayles, and the minimum resistivity is equal to 1,840 Rayles. Similarly, if one quarter (¼) of the total surface area of the cooling duct 30 is defined by the second portion 36, then n=0.25, the maximum resistivity is equal to 1,532 Rayles, and the minimum resistivity is equal to 920 Rayles.

The second portion 36 of the cooling duct 30 is positioned relative to the inlet 32 and the first portion 34 to allow drainage through the second portion 36 of liquids flowing into the inlet 32 of the cooling duct 30. As shown, the second portion 36 is positioned beneath the first portion 34, and at a lower elevation than the inlet 32 of the cooling duct 30. Accordingly, in the event any fluids are spilled into the inlet 32, the fluids will drain out of the cooling duct 30 through the porous material of the second portion 36, and will not drain into the energy storage system 22. The second portion 36 of the cooling duct 30 may include a permeability of at least 30 milliliters per second (ml/sec) to ensure proper drainage of any liquids spilled into the cooling duct 30. Alternatively, the cooling duct 30 may include a sump (not shown) configured for collecting fluids, and defining a weep hole (not shown) for draining the collected fluids from the sump over time.

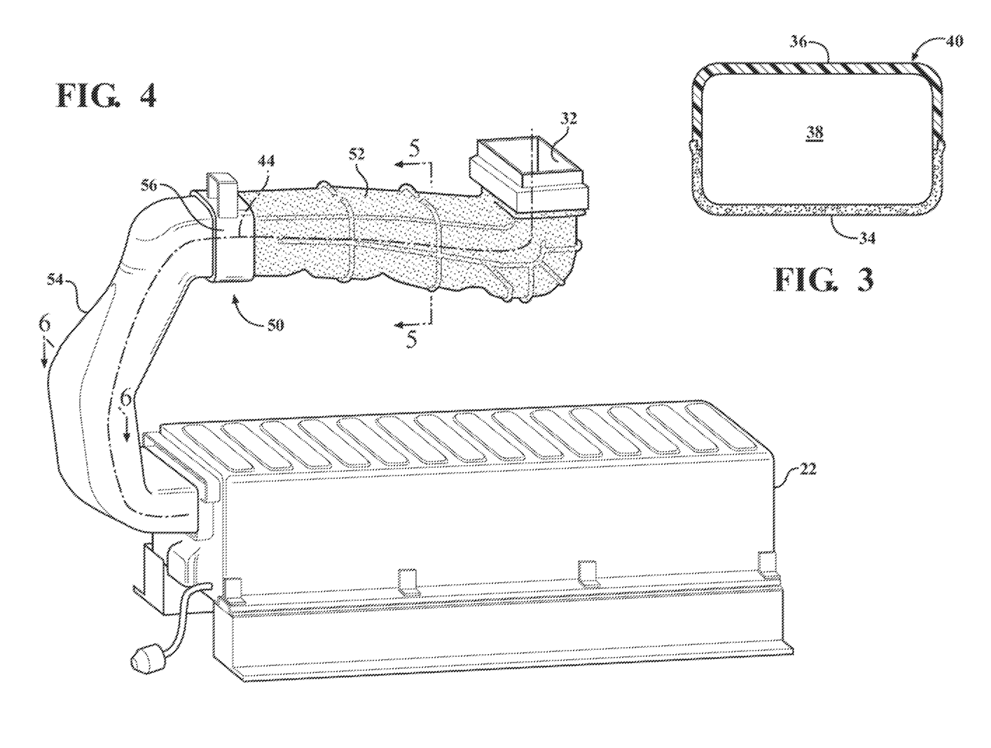

Referring to FIGS. 4 through 6, an alternative embodiment of the cooling duct is shown at 50. The cooling duct 50 includes a first portion 52 and a second portion 54. The entirety of the first portion 52 of the cooling duct 50 is formed from a non-porous material, such as described above. The entirety of the second portion 54 of the cooling duct 50 is formed from a porous material, such as described above. A coupling 56 interconnects the first portion 52 and the second portion 54 to define the entire length of the cooling duct 50.

As shown in FIG. 5, the first portion 52 of the cooling duct 50 includes a cross section defining a closed shape perpendicular to the longitudinal axis 44 of the cooling duct 50. Similarly, as shown in FIG. 6, the second portion 54 includes a cross section defining a closed shape perpendicular to the longitudinal axis 44 of the cooling duct 50. The first portion 52 and the second portion 54 are arranged end to end to define the enclosed flow path 38. The lengths of the first portion 52 and the second portion 54 may be adjusted to meet the various design requirements of the vehicle 20, including the air resistivity requirements described above.

While the best modes for carrying out the invention have been described in detail, those familiar with the art to which this invention relates will recognize various alternative designs and embodiments for practicing the invention within the scope of the appended claims.

1. A vehicle comprising:
a body defining a passenger compartment;
an energy storage system supported by the body and disposed externally of the passenger compartment; and
a cooling duct in fluid communication with the passenger compartment and the energy storage system and defining an inlet into the passenger compartment, wherein the cooling duct is configured for drawing a flow of air from the passenger compartment at a minimum flow rate and directing the flow of air to the energy storage system to cool the energy storage system;
wherein the cooling duct includes a first portion formed from a non-porous material and a second portion formed from a porous material and attached to the first portion to define an enclosed flow path for the flow of air; and
wherein the second portion includes an airflow resistivity allowing air infiltration through the porous material at a rate of between zero percent (0%) and twenty percent (20%) of the minimum flow rate when the inlet is unobstructed and at a rate of at least thirty percent (30%) when the inlet is completely obstructed.

2. A vehicle as set forth in claim 1 wherein the airflow resistivity allows air infiltration through the porous material at a rate of between zero percent (0%) and ten percent (10%) of the minimum flow rate when the inlet is unobstructed and at a rate of at least fifty percent (50%) when the inlet is completely obstructed.

3. A vehicle as set forth in claim 1 wherein the airflow resistivity is measured in Rayles and is equal to the quotient of a suction pressure within the cooling duct divided by a flow rate of the air through the cooling duct, multiplied by a surface area of the second portion of the cooling duct.

4. A vehicle as set forth in claim 3 wherein the airflow resistivity includes a maximum resistivity equal to:
maximum resistivity=(n)×(6,130 Rayles);
wherein “n” is equal to the percentage of the total surface area defined by the second portion of the cooling duct.

5. A vehicle as set forth in claim 3 wherein the airflow resistivity includes a minimum resistivity equal to:
minimum resistivity=(n)×(3,680 Rayles);
wherein “n” is equal to the percentage of the total surface area defined by the second portion of the cooling duct.

6. A vehicle as set forth in claim 1 wherein the second portion of the cooling duct is positioned relative to the inlet and the first portion to allow drainage through the second portion of liquids flowing into the inlet of the cooling duct.

7. A vehicle as set forth in claim 6 wherein the second portion of the cooling duct includes a permeability of at least 30 milliliters per second (ml/sec).

8. A vehicle as set forth in claim 1 wherein the first portion of the cooling duct includes a cross section having a non-linear shape perpendicular to a longitudinal axis of the cooling duct and the second portion includes a cross section having a non-linear shape perpendicular to the longitudinal axis of the cooling duct, wherein the non-linear cross sectional shape of the first section mates with the non-linear cross sectional shape of the second portion to define the enclosed flow path therebetween.

9. A vehicle as set forth in claim 8 wherein the non-linear cross sectional shape of the first portion of the cooling duct and the non-linear cross sectional shape of the second portion of the cooling duct each include a generally concave U-shaped configuration.

10. A vehicle as set forth in claim 1 wherein the first portion of the cooling duct includes a cross section defining a closed shape perpendicular to a longitudinal axis of the cooling duct and the second portion includes a cross section defining a closed shape perpendicular to the longitudinal axis of the cooling duct, wherein the first portion and the second portion are arranged end to end to define the enclosed flow path.

11. A vehicle as set forth in claim 10 further comprising a coupling interconnecting the first portion and the second portion.

12. A vehicle as set forth in claim 1 wherein the non-porous material of the first portion includes a plastic material, and wherein the porous material of the second portion includes a compressed mat of either natural fibers bonded together or synthetic fibers bonded together.

13. A cooling duct for connecting a passenger compartment of a vehicle and an energy storage system in fluid communication for directing a flow of air from the passenger compartment to the energy storage system to cool the energy storage system, the cooling duct comprising:
a first portion formed from a non-porous material; and
a second portion formed from a porous material and attached to the first portion to define an enclosed flow path for the flow of air;
wherein the second portion includes an airflow resistivity allowing air infiltration through the porous material at a rate of between zero percent (0%) and twenty percent (20%) of the minimum flow rate when the inlet is unobstructed and at a rate of at least thirty percent (30%) when the inlet is completely obstructed.

14. A cooling duct as set forth in claim 13 wherein the airflow resistivity allows air infiltration through the porous material at a rate of between zero percent (0%) and ten percent (10%) of the minimum flow rate when the inlet is unobstructed and at a rate of at least fifty percent (50%) when the inlet is completely obstructed.

15. A cooling duct as set forth in claim 13 wherein;
the airflow resistivity is measured in Rayles and is equal to the quotient of a suction pressure within the cooling duct divided by a flow rate of the air through the cooling duct, multiplied by a surface area of the second portion of the cooling duct;
the airflow resistivity includes a maximum resistivity equal to:
maximum resistivity=(n)×(6,130 Rayles); and
wherein the airflow resistivity includes a minimum resistivity equal to:
minimum resistivity=(n)×(3,680 Rayles);
wherein “n” is equal to the percentage of the total surface area defined by the second portion of the cooling duct.

16. A cooling duct as set forth in claim 13 wherein the second portion of the cooling duct includes a permeability of at least 30 milliliters per second (ml/sec).

17. A cooling duct as set forth in claim 13 wherein the first portion of the cooling duct includes a cross section having a non-linear shape perpendicular to a longitudinal axis of the cooling duct and the second portion includes a cross section having a non-linear shape perpendicular to the longitudinal axis of the cooling duct, wherein the non-linear cross sectional shape of the first section mates with the non-linear cross sectional shape of the second portion to define the enclosed flow path therebetween.

18. A cooling duct as set forth in claim 17 wherein the non-linear cross sectional shape of the first portion of the cooling duct and the non-linear cross sectional shape of the second portion of the cooling duct each include a generally concave U-shaped configuration.

19. A cooling duct as set forth in claim 18 wherein the first portion and the second portion are joined together to define a composite section, and wherein the cooling duct further comprises a third portion formed from a non-porous material and arranged end to end with the composite section to define the enclosed flow path.

20. A cooling duct as set forth in claim 13 wherein the first portion of the cooling duct includes a cross section defining a closed shape perpendicular to a longitudinal axis of the cooling duct and the second portion includes a cross section defining a closed shape perpendicular to the longitudinal axis of the cooling duct, wherein the first portion and the second portion are arranged end to end to define the enclosed flow path.
